(19) United States
(12) Patent Application Publication
(10) Pub. No.: US 2005/0134555 A1
(43) Pub. Date: Jun. 23, 2005

(54) Pointing device for detecting hand-movement

(75) Inventor: Zhi-Jian Liao, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., TAIPEI (TW)

(21) Appl. No.: 10/739,103

(22) Filed: Dec. 19, 2003

(51) Int. Cl. G09G 5/00

(52) U.S. Cl. 345/156

(57) ABSTRACT

The present invention discloses a pointing device for communicating with a computer system. The pointing device includes a micro control unit and at least two acceleration sensors respectively located at a first position and a second position. The pointing device may further include a wireless transmitting module that can wirelessly transmit a cursor-moving signal sent from the MCU. When a user operates the pointing device, the MCU calculates the difference in accelerations sensed by the two acceleration sensors, and sends the cursor-moving signal to the computer system. The pointing device further provides a laser pointer for facilitating the indication of content on a projected screen.

### BACKGROUND OF THE INVENTION

1. Field of the Invention

The present invention relates to a pointing device for communicating with a computer system or the like, and in particular to a pointing device for controlling cursor movement on a display according to the outputs of two inertia or acceleration sensors, hereinafter “accelerometers,” for sensing changes in direction and speed of the pointing device.

2. Description of the Prior Art

A conventional pointing device simply projects a laser light over a screen to highlight content relevant to a speech. However, it is not able to change the content, which must be programmed using a computer.

On the other hand, a computer system is usually operated while a user sits at a table so as to utilize a pointing device moving on the table. Thus, the user cannot move around the audience to provide a vivid presentation.

A small pointing device has been developed to overcome the inconvenience mentioned above by using a gyroscope, shown in U.S. Pat. No. 5,898,421, U.S. Pat. No. 5,828,350, and U.S. Pat. No. 5,594,169. However, the pointing device is costly to produce because of the need for a very precise gyroscope to detect hand-movement of a user.

In addition, WO0211058 discloses a simple improvement to conquer the defects listed above, in which a trackball device wirelessly transmits to a computer system so as to move a cursor on a display. In general, a trackball device is more difficult to operate by a single finger (thumb or index) over a working surface, such a desktop, than a computer mouse, which is the reason why the mouse is much more popular than the trackball in the market. To train a user to precisely operate a trackball in the air (suspending the user's arm away from the working surface) is a very tough task.

A Taiwan patent publication, TW526978, discloses a pointing device that uses an accelerometer to detect the hand-movement in the air, in which the accelerometer calculates or detects its own change in speed. However, the accelerometer fails to truly respond the complicated hand-movement in the air due to the impractical design. According to an experiment conducted by the inventor, the pointing device disclosed in the patent is almost inoperative.

### SUMMARY OF THE INVENTION

It is an object of the present invention to provide a stable and precisely controlled pointing device, which can truly respond to hand-movements so as to move a cursor on a display of a computer system.

It is another object of the present invention to provide a pointing device with a plurality of function keys for sending a command or execution to the computer according to the position of the cursor on the display.

It is yet another object of the present invention to provide a pointing device with a laser pointer for facilitating conduct of a presentation or explication on a projected screen.

It is yet another object of the present invention to provide a remote control to operate a digital TV or the like.

To accomplish the virtues described above, the pointing device comprises a micro control unit (MCU), and at least two accelerometers respectively located at a first position and a second position; and a wireless transmitting module that can wirelessly transmit a cursor-moving signal sent from the MCU. When a user operates the pointing device, the MCU calculates the difference in accelerations sensed by the two accelerometers, and sends the cursor-moving signal to a computer system.

### BRIEF DESCRIPTION OF THE DRAWINGS

FIG. 1 is a circuit diagram of the first embodiment according to the present invention.

FIG. 2 is a circuit diagram of the second embodiment according to the present invention.

FIG. 3 is a top view according to FIG. 2.

FIG. 4 is a diagram showing the movement when a user operates the preset invention.

FIG. 5 is a diagram showing the operation of the present invention connecting to a projector or computer.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention is a pointing device, which can be used to work with a computer system, a projector, or a digital TV system. The pointing device can be wired, or wirelessly communicate with the devices mentioned above. Hereinafter, the pointing device is, by way of example, illustrated as a wireless pointing device.

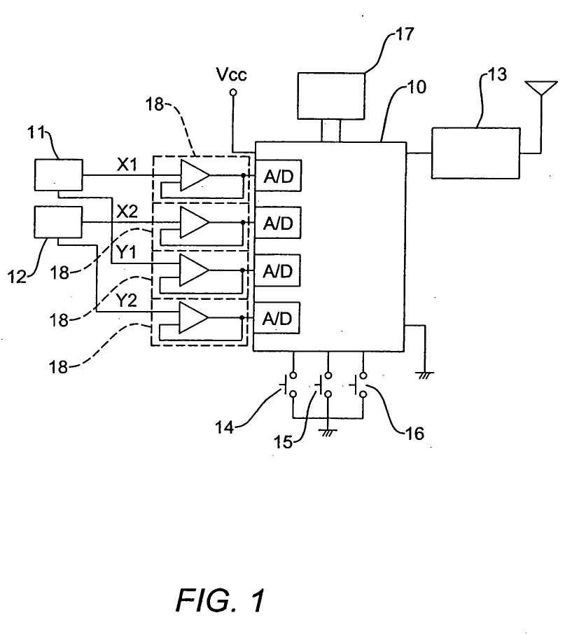

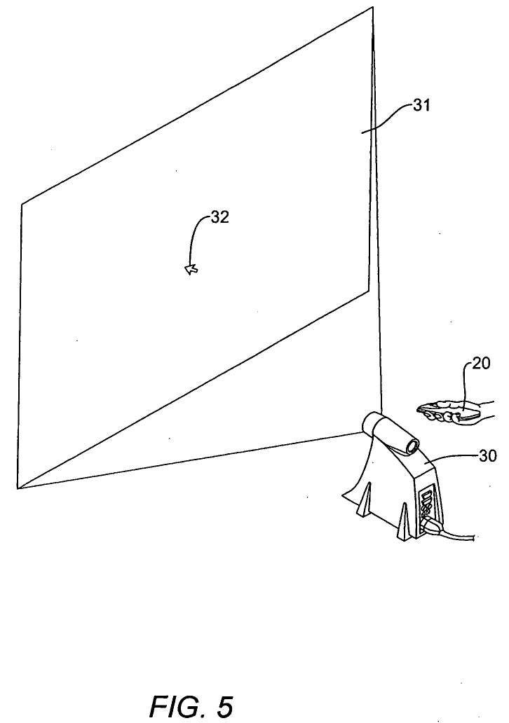

Referring to FIGS. 1, 3 and 5, the first embodiment of the present invention comprises a micro control unit (MCU) 10; at least two accelerometers 11, 12 respectively located at a first position and a second position; and a wireless transmitting module 13 arranged to wirelessly transmit a cursor-moving signal sent from the MCU 10. When a user operates the pointing device 20, for example by waving it in the air, the MCU 10 calculates the difference in accelerations sensed by the two accelerometers 11, 12, and sends the cursor-moving signal to a computer system or the like. Therefore a cursor 32 on the display (not shown) of the computer system 30 will move correspondingly.

In order to stabilize the output voltages of accelerometers 11 and 12, voltage follower 18 is respectively located between sensors 11, 12 and the MCU 10. A plurality of function keys 14, 15, 16 and 17, representing different key codes, are coupled to the MCU 10. Therefore, when a user operates the pointing device 20 to move the cursor 32 on the display (not shown), and clicks any of the keys, the pointing device will not only move the cursor on the display, but also correspondingly send a command or execution to the computer 30 (such as copy, delete, print, hyperlink . . . ) according to the position of the cursor 32 on the display (not shown). The function key 17 can be a roller like device for scrolling the content in an application window or for executing a Page Up/Page Down function.

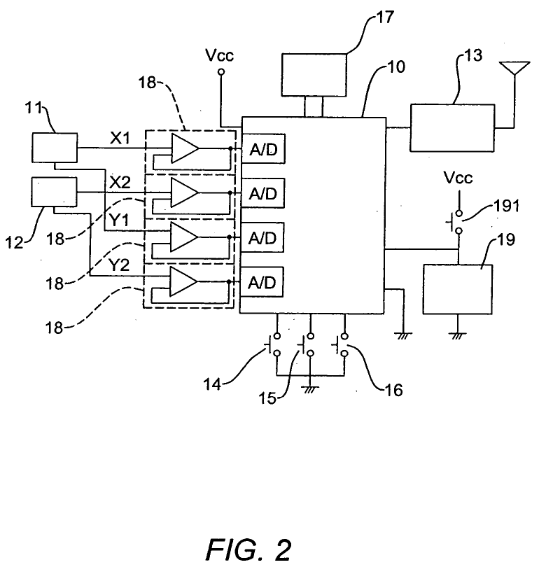

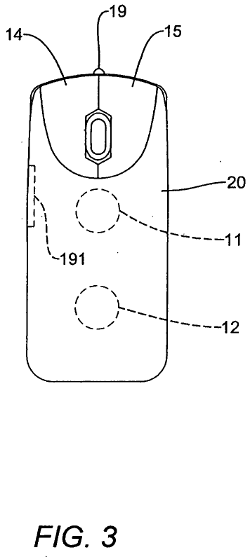

Referring to FIGS. 2 and 3, is the second embodiment of the present invention. A laser pointer 19 is further incorporated within the pointing device 20. The laser pointer 19 connects to power supply Vcc via a switch 191, and MCU 10. When the switch 191 is activated, the laser pointer 19 is connected to the Vcc and emits a light beam. When a user operates the pointing device 20, a cursor 32 projected by a projector 30 on the screen 31 will move correspondingly. The user can move the beam over a screen 31 for highlighting a projected content. However the MCU 10 may also enter a sleep mode to stop working and save the power of the pointing device 20.

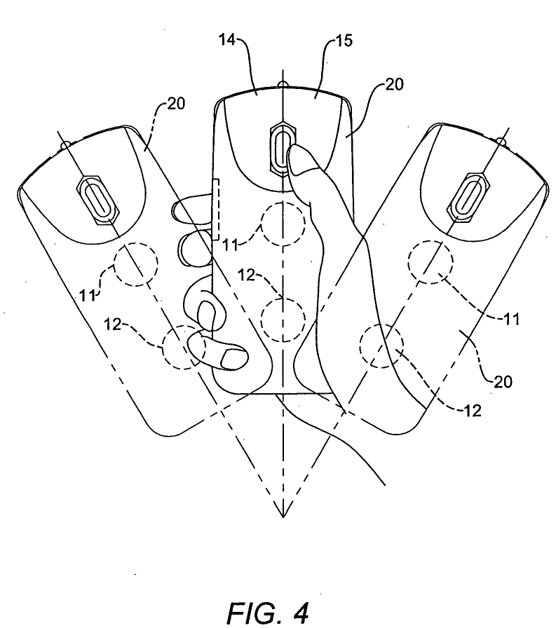

Referring to FIGS. 3 and 4, the shape or outline of the pointing device 20 can be ergonomically designed to match the hand, with the sensor 11 positioned at a front of the device and the sensor 12 positioned at a rear of the device. When the user operates the pointing device 20 in the air, the MCU 10 will receive two acceleration signals simultaneously. Then, the MCU 10 will calculate the difference between the two acceleration signals, and correspondingly generate a cursor-moving signal for transmission to the computer 30, so as to move the cursor 32 on the screen 31 and on the display of the computer. With key 191 is pressed, the laser pointer 19 will emit a light beam over the screen 31 for further indicating.

Please notice that the number of accelerometers is not limited to two, so long as the accelerations speeds detected by the sensors differ by an amount that enables calculation and comparison of the MCU 10 to generate a cursor-moving signal.

While the description above refers to particular embodiments of the present invention, it will be understood that many modifications may be made without departing from the spirit thereof. The accompanying claims are intended to cover such modifications as would fall within the true scope and spirit of the present invention.

1. A pointing device for communicating with a computer system, comprising:
a micro control unit which couples to at least two accelerometers;
wherein the micro control unit outputs a cursor-moving signal to the computer;
wherein the at least two accelerometers are positioned at least at a first position and a second position for detecting respective first and second changes in speed and direction of the pointing device; and
wherein when a user operates the pointing device, the micro control unit calculates the difference between the first and second changes in speed and direction so as to generate the cursor-moving signal for the computer.

2. The pointing device as claimed in claim 1, wherein the pointing device further has a wireless transmitting module for sending the cursor-moving signal to the computer.

3. The pointing device as claimed in claim 1, wherein the first position is at a front position and the second position is at a rear position of the pointing device.

4. The pointing device as claimed in claim 1, wherein the at least two accelerometers generate at least two voltages.

5. The pointing device as claimed in claim 1, wherein a voltage follower is disposed between each accelerometer and the micro control unit.

6. The pointing device as claimed in claim 1, wherein the micro control unit couples to a plurality of function keys.

7. The pointing device as claimed in claim 6, wherein one of the plurality of function keys is a roller.

8. The pointing device as claimed in claim 1, wherein the pointing device has a laser pointer, and a switch to activate the laser pointer.

9. The pointing device as claimed in claim 2, wherein the wireless transmitting module is a radio frequency transmitter.

10. The pointing device as claimed in claim 1, wherein the pointing device is a remote control, and the computer is a digital TV.

11. The pointing device as claimed in claim 1, wherein the pointing device is a remote control, and the computer is a projector.

12. A method to control a pointing device for communicating with a computer system, comprising:
obtaining at least two accelerations from, respectively, at least two accelerometers;
calculating a difference between the accelerations using a micro control unit;
outputting a cursor-moving signal from the micro control unit to the computer system.

13. A method to control a pointing device for communicating with a computer system, comprising:
obtaining at least accelerations at a first and a second position;
calculating a difference between the accelerations using a micro control unit;
outputting a cursor-moving signal from the micro control unit to the computer system.
